(19) United States
(12) Patent Application Publication
(10) Pub. No.: US 2005/0271094 A1
(43) Pub. Date: Dec. 8, 2005

(54) Method and apparatus for high power optical amplification in the infrared wavelength range (0.7-20 mum)

(76) Inventors: Robert John Dwayne Miller, Port Credit (CA); Kresimir Franjic, Toronto (CA); Darren Kraemer, Toronto (CA); Michel Piche, Quebec (CA)

Correspondence Address: Ralph A. Dowell of DOWELL & DOWELL P.C., 2111 Eisenhower Ave., Suite 406, Alexandria, VA, 22314, US

(21) Appl. No.: 11/129,649

(22) Filed: May 16, 2005

Related U.S. Application Data
(60) Provisional application No. 60/570,899, filed on May 14, 2004.

(51) Int. Cl. H01S 3/098; H01S 3/10

(52) U.S. Cl. 372/25; 372/18; 372/21

(57) ABSTRACT

A novel method for high power optical amplification of ultrashort pulses in IR wavelength range (0.7-20 Ãm) is disclosed. The method is based on the optical parametric chirp pulse amplification (OPCPA) technique where a picosecond or nanosecond mode locked laser system synchronized to a signal laser oscillator is used as a pump source or alternatively the pump pulse is created from the signal pulse by using certain types of optical nonlinear processes described later in the document. This significantly increases stability, extraction efficiency and bandwidth of the amplified signal pulse. Further, we disclose five new practical methods of shaping the temporal and spatial profiles of the signal and pump pulses in the OPCPA interaction which significantly increases its efficiency. In the first, passive preshaping of the pump pulses has been made by a three wave mixing process separate from the one occurring in the OPCPA. In the second, passive pre-shaping of the pump pulses has been made by spectral filtering in the pump mode-locked laser or in its amplifier. In the third, the temporal shape of the signal pulse optimized for OPCPA interaction has been actively processed by using an acousto-optic programmable dispersive filter (Dazzler) or liquid crystal light modulators. In the fourth alternative method, the signal pulse intensity envelope is optimized by using passive spectral filtering. Finally, we disclose a method of using pump pulses which interact with the seed pulses with different time delays and different angular orientations allowing the amplification bandwidth to be increased. In addition we describe a new technique for high power IR optical beam delivery systems based on the microstructure fibres made of silica, fluoride or chalcogenide glasses as well as ceramics. Also we disclose a new optical system for achieving phase matching geometries in the optical parametric interactions based on diffractive optics. All novel methods of the ultrashort optical pulse amplification described in this disclosure can be easily generalized to other wavelength ranges.

### CROSS REFERENCE TO RELATED U.S. APPLICATION

This patent application relates to, and claims the priority benefit from, U.S. Provisional Patent Application Ser. No. 60/570,899 filed on May 14, 2004, which is incorporated herein by reference in its entirety.

### FIELD OF THE INVENTION

The present invention relates to methods and devices for optical parametric chirp pulse amplification method and apparatus for high power optical amplification of ultrashort optical pulses in the infrared wavelength range.

### BACKGROUND OF THE INVENTION

High power ultra-short optical pulses have found numerous applications in the last two decades. Large peak powers of such pulses allowed accessing the highly non-linear regime of light-matter interactions. Laser spectroscopy, material processing, production of deep UV and X ray pulses are several fields that benefited greatly from these developments. The standard technique for production of such pulses is chirp pulse amplification (CPA). A review of this technique and applications of the ultrashort pulses can be found in Perry M D, Mourou G, “Terawatt to Petawatt subpicosecond lasers”, Science, 264 (5161) 917-924 (1994).

After years of development and great success, it is becoming increasingly clear that CPA technique is reaching its limits. Two major ones are gain narrowing and thermal deformations in the laser gain medium. Although there have been some clever improvements have with hollow fiber approaches and cryogenically cooled amplifiers to solve these problems; they don't provide potential for future scaling in power. Another problem with classical OPC systems is that they can provide amplified pulses only within certain wavelengths that in turn depend on the quantum mechanical level structure in the available laser gain materials.

Particularly, a major problem is in generation of ultrashort pulses in the IR spectral region (0.7-20 um). Such pulses have several significant scientific, technological, and medical applications. Many important vibrational transitions in organic molecules (O—H and C—H stretches for example.) or intersubband transitions in semiconductor nanostructures occur in this region. Practical applications of ultrashort pulses in this spectral range occur in medicine such as the ablation of biological tissues or photodynamic therapies. Currently, the prevailing method of generating such pulses involves optical parametric devices pumped by amplified ultrafast Ti:Sapphire laser systems. However, these systems are cumbersome, complicated to operate, and can not provide high power outputs.

In the last several years, an alternative technique for producing high power ultrashort laser pulses has emerged. The principle of optical parametric chirped pulse amplification (OPCPA) was first disclosed in A. Dubietis, G. Jonusauskas, and A. Piskarskas, “Powerful femtosecond pulse generation by chirped and stretched pulse parametric amplification in BBO crystal”, Opt. Commun. 88, 437-440 (1992) which since then has generated a great deal of interest for its potential to produce high energy ultrashort pulses. Dubietis et al disclosed stretching an ultrashort pulse by chirping it (typically ˜100 fs pulse is stretched to 0.1-0.5 ns) then amplifying the pulse in an optical parametric amplifier where it is approximately spatially and temporally overlapped with a high energy pump pulse in the phase matched configuration. After the amplification, the chirped pulse is compressed again to its original duration producing an ultrashort pulse with large energy

General OPCPA design considerations were disclosed later in I. N. Ross, P. Matousek, M. Towrie, A. J. Langley, and J. L. Collier, “The prospects for ultrashort pulse duration and ultrahigh intensity using optical parametric chirped pulse amplifiers”, Opt. Commun. 144, 125-133 (1997).

Although the method resembles standard chirped pulse amplification (CPA) there are significant differences. The physical interaction in the OPCPA is non-resonant which involves no thermal deposition. This offers an advantage over the conventional CPA technique in which thermal distortions severely limit high average power scaling. Other important advantages include improved pulse contrast, increased amplification bandwidth and higher gain. These advantages were discussed in Ross et al.

To date more then 60 articles have been published in international journals discussing and applying the OPCPA design. Still, the aforementioned OPCPA advantages have not been exploited to date due to several shortcomings. In order for an OPCPA system to become a useful laser tool several conditions must be fulfilled.

The first issue is stability of the output pulse. Interaction of the amplified ultra-short pulse with matter is very non-linear which means small fluctuations of the laser pulse intensity can cause large fluctuations in desired effect. In many applications, intensity stability levels of the amplified pulse have to involve amplitude changes of less than of 1-2%. It is a non trivial problem to produce such pulses from OPCPA's that typically operate in the high gain limit. Small variations of the pump pulse intensity can cause large variations of the output signal intensity. Typically 5-10% variations in stability have been achieved so far. Gain saturation is the standard solution but the saturation point has to be optimized by tuning the input pump and signal intensities. It is not easy to achieve that condition across the whole signal profile in the OPCPA amplifier since typically the temporal and spatial intensity profiles of the input pump and signal pulses are highly modulated.

Secondly, high energy conversion efficiency between pump and signal pulses is very desirable since it contributes to overall system compactness and efficiency. This conversion is largest in the saturation regime that can not be achieved easily. This is also a non trivial issue for the same reason mentioned in the last paragraph.

Thirdly, the amplification in the non-linear medium must preserve enough signal bandwidth to allow compression of the final pulse to short durations. This problem in bandwidth arises in the OPCPA for two reasons. The first one is the phase matching condition that has to be preserved between wave vectors of the three interacting optical waves. This problem is well known. The second reason is the wavelength chirp of the input signal pulse where spectral pulse profile is mapped into the temporal profile of the pulse. Trailing and leading pulse edges receive smaller gain than the central portion of the pulse which results in spectral narrowing of the output pulse.

Finally, the system has to be flexible in terms of choice of signal and pump wavelengths to allow amplification of the desired spectrum to be achieved with the most suitable pump sources.

Optical parametric amplification as a nonlinear process is critically dependent on the input signal and pump intensities. After the signal and pump pulses enter the nonlinear medium there is a periodic exchange of energy between them. At first, the energy transfers from the more energetic pump pulse to the signal. After a certain length the energy starts to flow back from the signal to the pump. This length is called the saturation length. It is dependent on the initial pump and signal intensities and the amount of the pump-signal phase mismatch. Unless the pump and signal optical waves are close to the saturation point the speed of energy transfer is very large. This can cause additional noise in the amplified pulse and reduced conversion efficiency.

In the article by Dubietis et al. discussed above, the original OPCPA technique was proposed. The pump pulse was derived from the signal pulse by using a beam splitter and amplified in a regenerative amplifier. Although this scheme generates well synchronized pump pulses there is no flexibility in choosing the pump wavelength. The same problem exists in the method described in EU Patent CN1297268.

In U.S. Pat. No. 6,181,463 issued to Galvanauskas et al. long pump pulses are used (>1 ns) and triggered electronically to make them in sync with the signal pulse. This approach gives poor conversion efficiency because of the bad overlap between signal and pump pulses. The electronics triggering also introduces timing noise.

In U.S. Pat. No. 6,873,454 issued to Barty et al. a solution for this problem is presented where OPCPA is combined with a classical laser amplifier. Although this approach solves the efficiency and timing problem with electronically triggered long pump pulses it is not flexible in terms of choosing signal wavelength and also is not suitable for amplification of very short pulses because of the problem with gain narrowing in the classical amplifier.

A solution for optimizing intensity pump and signal profiles for OPA interaction is disclosed in Giardalben et al, Optics Express, Vol 11, Issue 20, 2511-2524 (2003), but the solution relies on using fast electro-optics. Such an approach does not give enough control and precision for controlling these profiles. Further, electro-optical components are cumbersome and not used easily.

### SUMMARY OF THE INVENTION

The present invention provides an optical pulse amplification system,
comprising: a) a first mode-locked laser for producing a seed laser pulse;
b) a second mode-locked laser for producing a pump laser pulse;
c) pulse stretcher means for stretching said seed laser pulse to produce a stretched seed laser pulse;
d) a nonlinear optical medium and directing means for spatially overlapping and directing said stretched seed laser pulse and said pump laser pulse into said non-linear optical medium and producing an output amplified stretched seed laser pulse; and
   e) means for synchronizing the first and second mode-locked lasers to each other such that a time delay between arrival of the first stretched seed laser pulse and said pump laser pulse at the nonlinear optical medium fluctuates in time by an amount shorter than pulse durations of the stretched seed laser pulse and said pump laser pulse to give substantially temporally and spatially overlapped stretched seed laser pulse and pump laser pulses.

The present invention also provides a method of laser pulse amplification, comprising the steps of:
generating an seed laser pulse from a first mode-locked laser;
stretching said seed laser pulse to produce a stretched seed laser pulse;
generating a pump laser pulse from a second mode-locked laser; and
directing said stretched seed laser pulse and said pump laser pulse into an
   nonlinear optical medium and producing a nonlinear optical medium output amplified signal pulse, the first and second mode-locked lasers being synchronized to each other such that a time delay between arrival of the first stretched seed laser pulse and said pump laser pulse at the nonlinear optical medium fluctuates in time by an amount shorter than pulse durations of the stretched seed laser pulse and said pump laser pulse to give substantially temporally and spatially overlapped stretched seed laser pulse and pump laser pulses.

The present invention provides a method and apparatus for generating high power ultrashort pulses, preferably in the IR spectral range (0.7-20 Ãm) by using an of optical parametric chirped pulse amplification (OPCPA) system in which pump pulses are produced from a mode-locked laser system synchronized to a mode-locked laser which produces seed laser pulses, both of which are directed to a non-linear material in which energy from the pump pulse is transferred to the seed pulse thereby amplifying it.

The method may use passive or active pre-shaping of the intensity envelopes of the pump pulses before they interact with the signal pulses, or the seed pulses may be modified by active preshaping of the intensity envelope of the seed pulses.

The present invention also provides an optical pulse amplification system, comprising:
a) a first mode-locked laser for producing a seed laser pulse;
b) means for spectrally broadening a portion of the seed laser pulse coupled to the first mode-locked laser for producing a spectrally broadened portion of a seed laser pulse;
c) soliton wavelength selection means, wherein said spectrally broadened portion of a seed laser pulse is directed into said soliton wavelength selection means wherein a soliton wavelength is selected and a duration of the spectrally broadened portion of a seed laser pulse is adjusted to produce a pump laser pulse;
d) pump laser pulse amplifier for amplifying said pump laser pulse;
e) pulse stretcher means for stretching said seed laser pulse to produce a stretched seed laser pulse; and
d) a nonlinear optical medium and directing means for spatially overlapping and directing said stretched seed laser pulse and said pump laser pulse into said non-linear optical medium and producing an output amplified stretched seed laser pulse.

These and other objects will be apparent based on the disclosure within.

### BRIEF DESCRIPTION OF THE DRAWINGS

For a better understanding of the present invention and to show more clearly how it may be carried into effect, reference will now be made, by way of example, to the accompanying drawings which show a preferred embodiment of the present invention and in which:

FIG. 1a) shows the temporal overlap between pump and signal laser pulses in a conventional (prior art) OPCPA method which relies upon a large difference between the pump and signal laser pulse duration to compensate for the lack of timing stability between the two pulses;

FIG. 1b) shows that in the present method, the synchronization of pump and signal mode-locked lasers allows the duration of the two input laser pulses to be within the same order of magnitude, without sacrificing temporal stability of the amplification;

FIG. 2 is a block diagram of an embodiment of an apparatus for optical amplification constructed in accordance with the present invention;

FIG. 3 shows several combining elements for different spatial geometries including a) collinear b) noncollinear with collimated beams c) noncollinear with focused beams d) noncollinear with a transmissive diffractive optic e) noncollinear using reflective diffractive optic;

FIG. 4 is a block diagram of an embodiment of an apparatus for optical amplification similar to the system of FIG. 3 but including a pulse compressor

FIG. 5 is a block diagram of an alternative embodiment of an apparatus for optical amplification;

FIG. 6 is a block diagram of another alternative embodiment of a an apparatus for optical amplification;

FIG. 7 is a block diagram of another alternative embodiment of an apparatus for optical amplification;

FIG. 8 is a block diagram of another alternative embodiment of an apparatus for optical amplification;

FIG. 9 so a block diagram of method of shaping signal pulse intensity profiles for optimizing parametric amplification; and

FIG. 10 so a block diagram of method of shaping pump pulse intensity profiles for optimizing parametric amplification.

### DETAILED DESCRIPTION OF THE INVENTION

Definitions

A mode-locked laser is a laser that functions by modulating the energy content of each laser resonator's mode internally to give rise selectively to energy bursts of high peak power and short duration in the sub-nanosecond domain.

When we refer at least two mode locked lasers being synchronized this means they are synchronized to each other such that a time delay between arrival of the first stretched seed laser pulse and said pump laser pulse at the nonlinear optical medium fluctuates in time by an amount shorter than pulse durations of the stretched seed laser pulse and said pump laser pulse to give substantially temporally and spatially overlapped stretched seed laser pulse and pump laser pulses in the nonlinear gain media.

By timing jitter we mean random variation in the timing of arrival of laser pulses at a certain point relative to a specified clock. In the present application the clock is defined by a pulse train of a signal mode-locked laser.

Diffractive optics means optical elements that diffract incident laser beam pulses with certain wavelengths under pre-determined specific angles depending on the laser beam wavelength and the point of incidence.

Nonlinear optical material refers to an optical material that possesses a strong nonlinear dielectric response function to optical radiation. The non-linear medium used in the present invention is selected to give energy transfer from the second laser pulses to the first laser pulses through a non-linear optical interaction.

Combining elements are optical elements that direct, and/or shape, and/or focus a laser beam such that it is incident at a determined position with determined size and under determined angle. Common examples include mirrors, lenses, wedges, prisms, wavepleates, polarizers, beam-splitters, filters and any combination thereof, etc. Their usage is well known to people skilled in art.

We disclose two methods for generating well shaped and synchronized short optical pump pulses in the present OPCPA design.

The first method, referred to as synchronization method 1 includes using any mode-locked pump laser system that is actively or passively synchronized to a mode-locked signal laser and produces pulses with durations that are approximately equal to stretched signal pulses before the amplification. Well designed mode-locked laser systems can produce pulses with less then 1% intensity fluctuations.

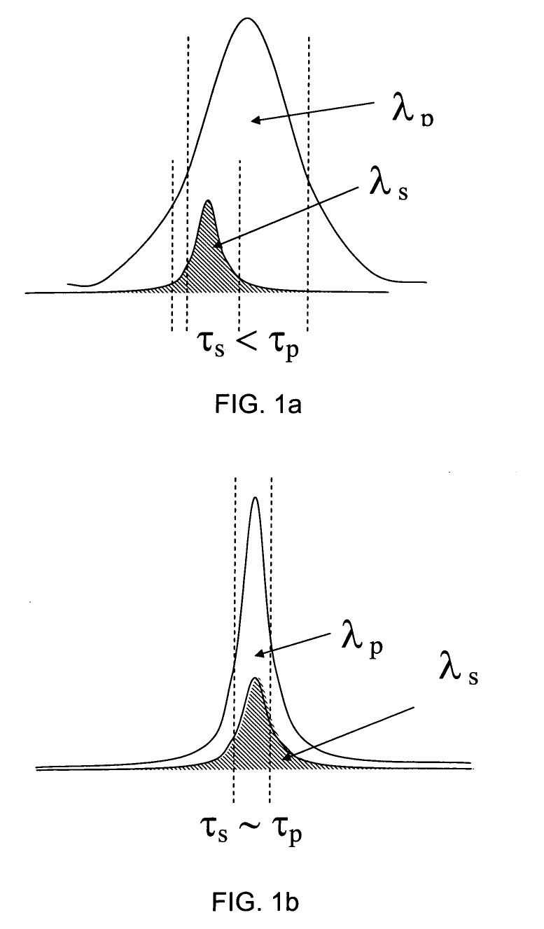

FIGS. 1a) and 1b) show diagrammatically the difference between one of the known prior art OPCPA methods and the method disclosed herein. In these conventional OPCPA methods the pump pulses have nanosecond pulse (>1 ns) durations and are generated from high power laser sources with poor timing control, see FIG. 1a). Typical examples are Q switch lasers. In order to have good temporal overlap between signal and pump laser pulses in the non-linear optical medium the signal pulse has to be stretched impractically long or it has only partial overlap (τₛ<τₚ) with the pump pulse thereby sacrificing a large portion of the pump pulse energy. The second problem is the presence of large temporal fluctuations of the arrival of the pump pulses at the non-linear medium. This results in creating intensity fluctuations of the amplified signal pulse.

In synchronization method 1 disclosed herein, the pump pulse is generated from a mode locked laser which is passively or actively synchronized with a mode-locked signal laser. There are methods well known to people skilled in art for controlling pulse durations from such lasers by adjusting the mode-locked laser parameters or placing a bandwidth limiting element within the mode-locked laser resonator. Further, there are well-known methods of synchronizing two independent lasers with relative timing jitter much smaller than typical durations of the signal pulses in the OPCPA systems. This allows precise temporal overlap between signal and pump pulses (τₛ˜τₚ) in the non-linear medium as shown in FIG. 1b, thereby allowing significant improvements in conversion efficiency and amplification stability. An advantage of this method is the possibility of using higher pump intensities in the OPCPA amplifier allowing larger gains. The last property is a consequence of the fact that the intensity damage threshold for non-linear crystals increases with decreasing pulse duration. It is important to note the difference between this method and the prior art discussed in EU Patent CN1297268. In this prior method, both signal and pump pulses originate from the same mode-locked laser with pump pulse amplified and wavelength shifted through second or third harmonic generation. Although this method also produces well synchronized pump and signal pulses the possible signal and pump wavelength combinations are limited. In the method disclosed herein, any signal and pump wavelength combination is possible.

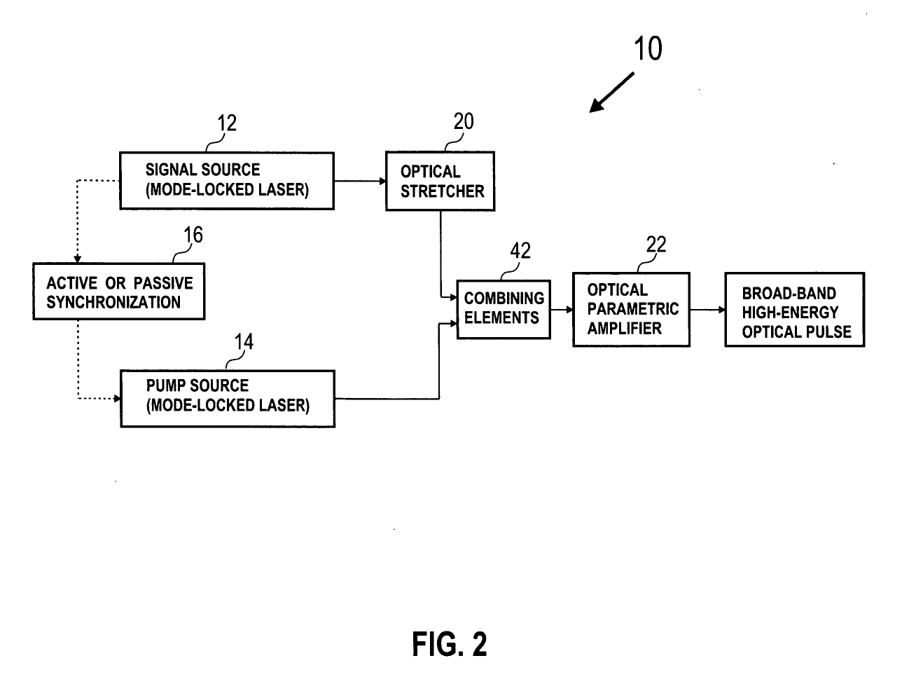

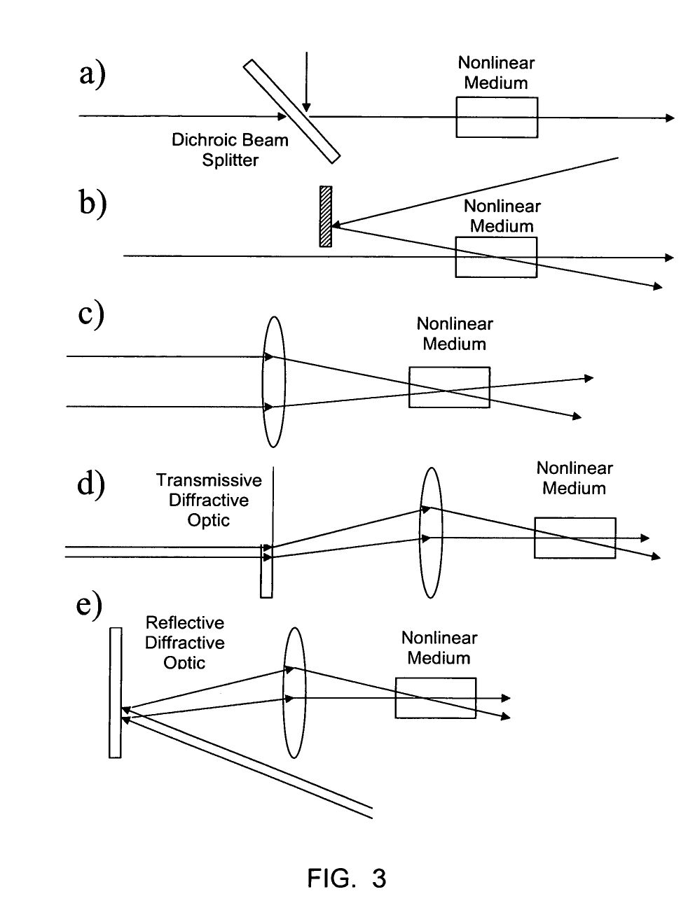

FIG. 2 shows a block diagram of an optical pulse amplification system shown generally at 10 which includes a mode-locked laser 12 as a signal source generating optical pulses with duration in the first time regime (τs); a pump source which includes a mode-locked laser 14 different from the signal source 12 that generates pulses in the second longer time regime (τp). The mode-locked laser 14 can be actively or passively mode-locked. The system includes an active or passive synchronization system 16 that synchronizes the signal and pump mode-locked lasers 12 and 14 with relative timing jitter better then 50% of the upper limit of the second time regime. The system 10 includes pulse stretcher 20 that stretches said signal mode-locked pulses to a duration approximately equal to the duration of said pump mode-locked pulses; combining elements 42 which receive and combine the pump pulses and the signal pulses, to thereby provide combined pulses which are substantially temporally and spatially overlapped appropriately for subsequent amplification in the nonlinear parametric gain media. FIG. 3 shows several non-limiting configurations of optical combining elements for different spatial geometries including a) collinear b) non-collinear with collimated beams c) non-collinear with focused beams d) non-collinear with a transmissive diffractive optic e) non-collinear using reflective diffractive optic.

System 10 includes an optical parametric amplifier 22 comprising a nonlinear optical material for receiving the combined pump and signal pulses and amplifying the signal pulses using energy of the pump pulses. The non-linear material possesses a strong nonlinear dielectric response function to optical radiation which gives rise to substantial energy transfer from the pump pulse to the signal pulse through non-linear optical interaction.

The wavelengths λₚ, λₛ and λᵢ of the pump, signal and idler beams respectively must satisfy phase matching-conditions:
1/λₚ=1/λₛ₊1/λᵢ
nₚ/λₚ=nₛ/λₛ₊nᵢ/λᵢ
where nₚ, nₛ and nᵢ are refractive indices of the pump, signal, and idler waves in the non-linear medium respectively.

Optimizing the choice and orientation of the non-linear medium to satisfy these conditions is well known to the people skilled in the art.

The nonlinear medium of the parametric amplifier 22 may be any of the following nonlinear crystals; KnBO₃, MgO:LiNbO₃, BBO, LBO, RTA, KTA, KTP, AgGaSe₂, AgGaSe, or any listed in the attached crystal bibliography [6]. The nonlinear medium may be a quasi-phase matched crystal, including periodically poled versions of all crystals listed in [6], e.g., PPLN, PPKTP and PPKTA.

One or both of the pump sources 14 or signal sources 12 may contain a mode locked fibre laser. Specifically where the signal laser can be a high-bandwidth erbium doped fibre laser at 1.5 μm and/or the pump source can contain a Yb-doped fibre laser at 1.0 μm Combining fibre laser technology with parametric amplification to yield compact and robust sources of high-energy IR pulses.

The pump source 14 may include a mode locked solid state rare-earth doped laser or the second or third harmonics of that laser system. The signal source may be a mode locked Titanium Sapphire laser with or without optical absolute carrier phase stabilization, or the second or third harmonics of that laser system.

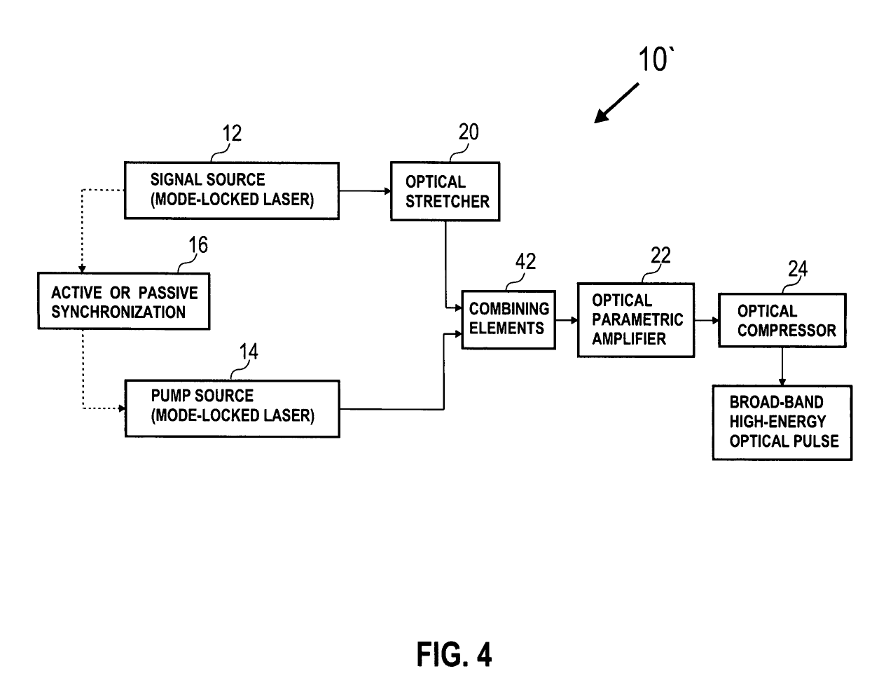

The output of the non-linear amplifier medium 22 may be useful for some applications by itself. In a preferred embodiment shown in the FIG. 4, a system 10′ may include a compressor 24 optically coupled to the output of the amplifier 22 which compresses the amplified optical signal to a shorter time regime and which outputs ultrafast high energy pulses.

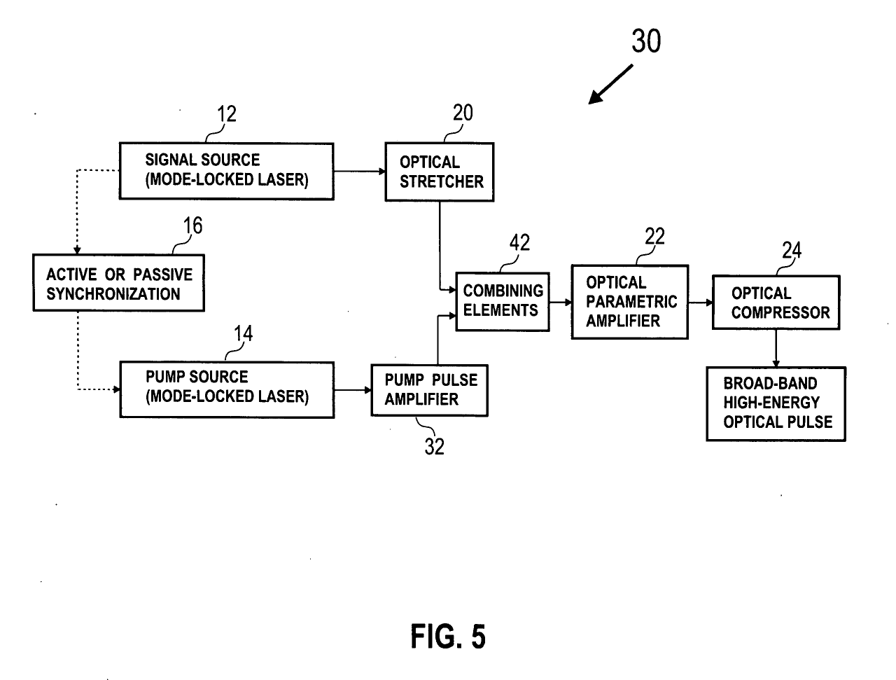

Referring to FIG. 5, to achieve still higher pump pulse energy, the synchronized pump mode-locked laser pulses can be subsequently amplified in conventional regenerative and multipass amplifiers to large levels suitable for pumping of an OPCPA. An important example of such a pump system is the rare earth doped solid-state laser technology where the wavelength of the pump mode-locked laser is chosen to match any of the laser crystals with lasing emission wavelengths around 1 um (like Nd:YLF, Nd:YAG, Nd:YVO4, Yb:YAG etc). Amplifiers based on these crystals belong to mature and established technology and can produce pulses with energies up to several Joules. In an embodiment of the system shown at 30 in FIG. 5, pump pulses from the pump mode-locked laser 14 are amplified in a pump amplifier 32 before they are recombined with the signal pulses in the parametric amplifier 22. Also the compressor 24 can be excluded if only short pulse durations are not needed.

The combining elements 42 may include one or more diffractive optics as shown in FIGS. 3d and 3e, used to achieve any necessary spatial geometry for optimal phase matching of the pump and seed pulses in said parametric amplifier. The use of a diffractive optics as beam delivery tool for phase matching has recently been exploited in spectroscopy experiments. This technique has not been used with OPA or OPCPA technology to date. When combined with the OPA or OPCPA technique it can allow the use of complicated spatial phase matching geometries in a simple and effective manner, thereby increasing the gain and bandwidth of the amplification process.

Extension of this method can include any combination of independent mode-locked laser systems producing pump pulses with different wavelengths which are all synchronized to the same signal mode-locked laser. The output of these pump mode-locked lasers (which could be amplified) can be used for pumping a multistage OPCPA.

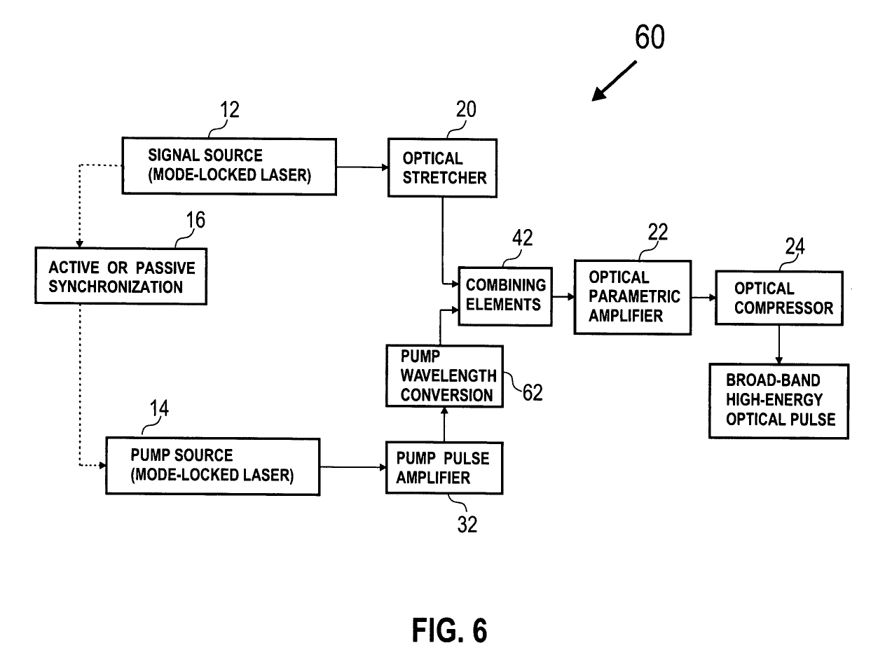

Because of phase matching constraints it can happen that the optimal pump wavelength in the OPA is not the same as the one derived from the mode-locked pump laser. In that case pump wavelength can be shifted before OPA by harmonic generation (like SHG, THG etc) in a non-linear medium. This embodiment is shown on FIG. 6 with a new element 62 where pump wavelength conversion takes place.

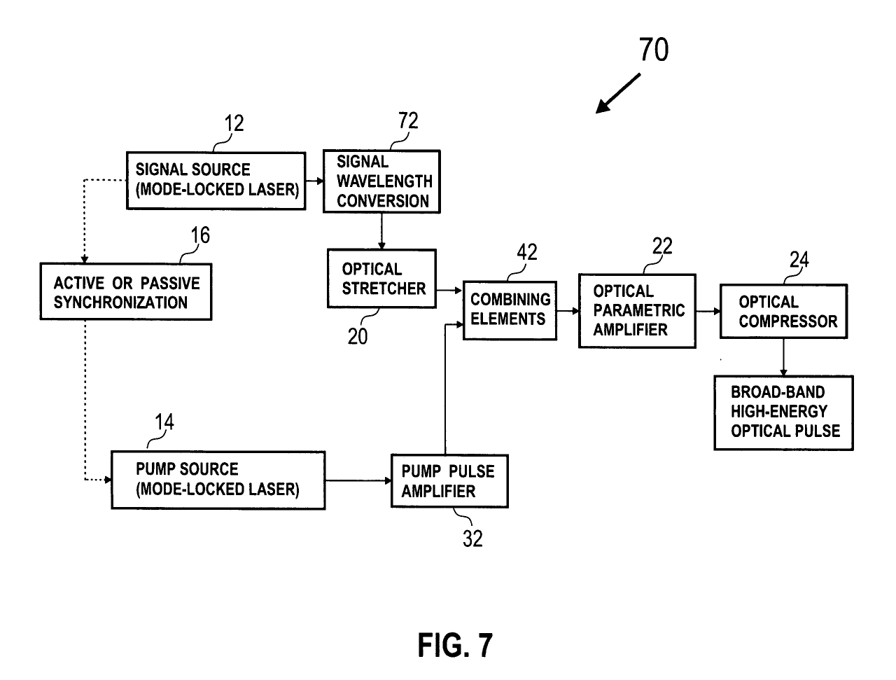

Similarly, it may be beneficial to change the signal pulse wavelength before the pulses enter the OPA. That wavelength can be shifted by using methods well known to the people skilled in art. Examples include SHG, THG, spectrum broadening and/or shifting in fibers etc. The embodiment is represented on the FIG. 7. Alternatively the signal wavelength shifting system 72 can be placed before the stretcher 20.

Systems 60 and 70 can be implemented without optical compressor 24 if a short output pulse duration is not needed.

Synchronization Schemes

Several possible synchronization schemes can be implemented between the signal mode-locked laser 12 and the pump mode-locked laser 14 in the different embodiments shown in FIGS. 2 and 4 to 7. These schemes are discussed in the following paragraphs. Each of these schemes can be applied to the aforementioned OPCPA methods and also to any combination of the OPCPA methods described herein. In all these schemes the signal mode-locked laser 12 may be either passively or actively mode-locked.

Each of the following synchronization schemes can be used, but the aforementioned OPCPA methods are not limited to them.

Scheme 1

The pump mode-locked laser is actively mode locked by amplitude or frequency modulators where the RF driving signal for these modulators is provided by RF filtering of the fundamental RF frequency or one of its harmonics of the electrical signal from the photo detector observing the pulse train from the signal mode-locked laser. Alternatively, the RF driving field for modulators can be created by electronically dividing or multiplying in integer multiples the fundamental RF frequency or one of its harmonics from the electrical signal output of a photo detector observing the pulse train from said mode-locked laser. In addition, phase locked loops can be employed to reduce the relative timing jitter between said signal and said pump mode-locked lasers. Analog or digital phase detectors detect the phase error between trains of electrical pulses coming from photo detectors observing optical pulse trains from said signal and said pump mode-locked lasers. The phase error is then electronically converted to the phase correction signal applied either on the RF signal coming to the modulators or to the position of the translation stage on which one of the pump laser end mirrors is mounted.

Scheme 2

The variant of the Scheme 1 can be employed where an additional cavity dumping element inside the said pump mode-locked laser is installed. The cavity dumping element dumps the mode-locked pump pulses directly from the resonator which results in larger pump pulse energies. Even larger improvements can be realised by placing additional Q-switching elements inside the said pump mode-locked laser to increase the pump pulse energy

Scheme 3

The pump mode-locked laser is a passively mode locked laser (e.g. by using saturable absorbers or Kerr lens mode-locking). The synchronization with the said signal mode-locked laser is achieved by dynamic control of the pump mode-locked laser cavity length. Analog or digital phase detectors detect the phase error between trains of electrical pulses coming from photo detectors observing optical pulse trains from said signal and said pump mode-locked lasers. The phase error is then electronically converted to the phase correction signal which is then used to control the position of the translation stage on which one of the pump laser end mirrors is mounted. Readjusting the cavity length then takes place until the phase error is minimized.

Scheme 4

The pump mode-locked laser is passively mode locked by using a saturable absorber. The fraction of the mode-locked pulses from the said signal mode-locked laser is converted to pulses with a wavelength that is within absorption spectrum of the saturable absorber. If these converted pulses are made incident on the saturable absorber such that the incidence spot is overlapped spatially with the incidence spot for the intra-cavity pump mode-locked pulse, the pump mode-locked laser dynamics will favour operation when the cavity loss of the said pump mode-locked laser is minimized. This will lead to synchronization of the optical pulse trains from said signal and said pump mode locked oscillators. For converting the energy of the signal mode locked pulses to pulses and wavelengths which are incident on the saturable absorber the techniques mention above can be used.

An alternative method for creating pump pulses well synchronized to the signal pulses can be done by utilizing optical nonlinear processes. This method is referred to as synchronization method 2. Not only does this approach allow to minimize the jitter between pump and signal pulses, it provides a method to control the phase of the idler wave produced through the OPCPA process. It is well known that the phase of the idler wave is sensitive to the phase of the pump and signal pulses. The equations found in reference B. A. Saleh and M. C. Teich, “Fundamentals of Photonics”, Wiley, (1991) chapter 19, pages 762-774 reveal that the rate of growth (along the z-axis) of the idler wave scales proportionally with the complex field amplitude of the pump and signal pulses; those complex field amplitudes include the phase of the pump and signal pulse. This pump pulse could be derived from the continuum generated in a high nonlinearity optical fibre, such as tapered fibres or various forms of microstructure fibres, or fibres made of a highly nonlinear glass material (chalcogenide glasses are one potential example).

The process of continuum light generation in a high nonlinearity fibre provides a pathway to generate a reference, phase-locked optical pulse with respect to the pulse that has generated the continuum. It is generally believed that continuum light is generated as follows in high-nonlinearity fibres, at least for low-intensity femtosecond pulses (this would certainly apply to the case of 100-fs, 1-nJ pulses from a mode-locked erbium-doped fibre laser). The fibre dispersion is such that its second-order dispersion vanishes in the vicinity of the pulse central wavelength. The basic idea is that the fibre dispersion becomes anomalous for wavelengths above 800 nm (up to roughly 1600 nm). The part of an input pulse in the wavelength range with anomalous dispersion becomes a higher-order soliton with number N (N being larger than unity); that N soliton breaks into many fundamental solitons (i.e. of order N=1) This phenomenon was discussed by Hermann et al, Experimental evidence for supercontinuum generation by fission of higher-order solitons in photonic fibres”, Phys. Rev. Lett., vol. 88, paper 173901 (2002).

These fundamental solitons have a spectrum at red-shifted wavelengths with respect to the input pulses, when these input pulses come from a Ti:Sapphire laser emitting around 800 nm; it would be the other way if the pulses come from an erbium-doped fibre laser emitting at 1550 nm. By changing the parameter of the input pulses (duration, energy), one changes the order N of the initial high-order soliton. By changing N, one can change the number of frequency-shifted solitons, and the position of their central wavelength. The generation of frequency-shifted solitons in the anomalous dispersion region is accompanied by the emission of phase-matched nonsolitonic radiation in the wavelength range with normal dispersion. This nonsolitonic radiation takes the shape of optical pulses whose central wavelength is adjusted by the soliton order N. These mechanisms are well-illustrated in FIG. 1c) of the manuscript referred above [9]. This approach allows for the production of optical pulses covering a broad frequency range; these optical pulses (solitons and nonsolitonic radiation) are synchronized and phase locked to the signal pulse.

In short, according to this scheme, one could tune a specific optical pulse to the gain center of a regenerative amplifier used to pump the OPCPA. Injection seeding the regenerative amplifier with such a pulse allows for a full control of the timing and of the phase of the pump pulse to be used in the OPCPA.

This description of continuum generation seems to be validated with low-power, long pulses (100-fs duration and above). The key element is to have an input pulse with sufficient power to correspond to a high-order soliton (of order N=2 and above). This can be realized with longer pulses, or with short pulses of higher energy.

If continuum generation (or spectral broadening) is produced according to another mechanism, the same picture of injection seeding the regenerative amplifier with the same source that produces the pulses to be amplified would lock the phase of the idler wave generated through parametric amplification, and would also synchronize the amplifier with respect to the seed source.

It should be noted that the method based on continuum generation (or spectral broadening) in a high-nonlinearity fibre is fundamentally different from the process of soliton self-frequency shift taking place in standard optical fibres currently used for telecommunications. In the process of soliton self-frequency shift the carrier frequency of a single, solitonic pulse shifts to the red due to Raman-type interactions.

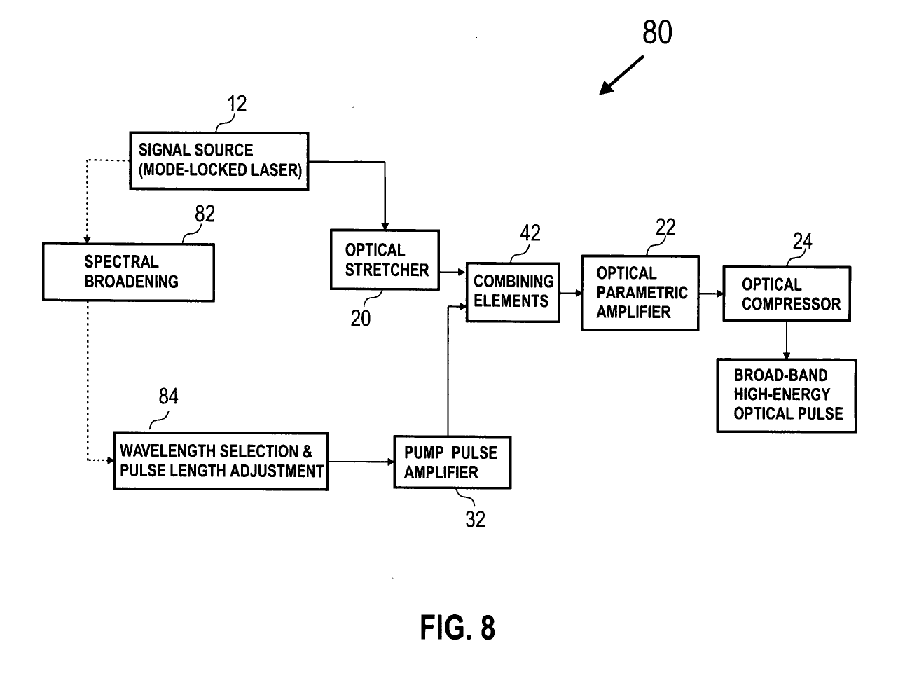

FIG. 8 shows a block diagram of an optical pulse amplification system shown generally at 80 which includes a mode-locked laser 12 as a signal source generating optical pulses with duration in the first time regime (τs); a device 82 that is optical coupled to mode-locked laser 12 and in which portion of the seed pulse is injected and where that portion undergoes significant spectral broadening. Examples of device 82 include a high nonlinearity optical fibre, such as tapered fibres or various forms of microstructure fibres, or fibres made of a highly nonlinear glass material (chalcogenide glasses are one potential example).

The spectrally broadened pulse from 82 is subsequently injected into device 84 where soliton wavelength is selected and duration adjusted to generate desired pump pulse for the amplifier 22. The pump pulse is amplified in the pump amplifier 32 before amplifying the seed pulse in the amplifier 22. The optical compressor 24 can be placed after the amplifier 22 in case if shorter durations of the amplified pulse are desired.

There are many ways of selecting a soliton or a pulse of nonsolitonic radiation produced through continuum generation in microstructured or tapered fibres (the method does not require the seeded pulse to be a soliton; continuum generation also produces pulses of nonsolitonic radiation). Among possible methods, there are listed as flollows. 1) The gain linewidth of the active medium in the pump pulse amplifier. 2) filters introduced in the cavity of the pump pulse amplifiers, such as: a single birefringent filter, or a combination of many birefringent filters; a single prism, or a combination of many prisms; a single thin-film filter, or a combination of many thin film filters; a single Fabry-Perot étalon, or a combination of many Fabry-Perot étalons; other optical interferometers (Michelson, Mach-Zehnder, Fox-Smith, or a combination of many optical interferometers; a single diffraction grating (including holographic gratings), or a combination of many diffraction gratings (including holographic gratings); a single volume hologram, or a combination of many volume holograms; any arrangement combining any of the afore-mentioned filters. 3) Same filters mentioned in 2), but positioned between the nonlinear medium that has produced spectral broadening and the pump pulse amplifier. 4) A single fibre Bragg grating, or a combination of many fiber Bragg gratings, positioned between the nonlinear medium that has produced spectral broadening and the cavity of the pump amplifier.

Optimizing Intensity Profiles of the Pump and Signal Pulses

Optical parametric amplification as a nonlinear process is critically depended on the input signal and pump intensities. After the signal and pump pulses enter the nonlinear medium there is a periodic exchange of energy between them. At first, the energy transfers from the more energetic pump pulse to the signal. After a certain length the energy starts to flow back from the signal to the pump. This length is called the saturation length. It is dependent on the initial pump and signal intensities and the amount of the pump-signal phase mismatch. Unless the pump and signal optical waves are close to the saturation point the speed of energy transfer is very large. These causes critical dependence of output signal level to input pump fluctuations if operating point is away from saturation. This feature is undesirable since it introduces noise.

The other unwanted effect of the high gain in the OPA is bandwidth narrowing. Since the signal pulse is chirped it has temporal modulation that corresponds to its spectrum. The central, more intense part of the signal pulse receives more gain than its wings resulting in the spectral narrowing or the output pulse.

Both problems can be reduced if intensity profiles of the input pump and signal pulses are tuned such that all spatial-temporal points of the signal pulse reach gain saturation at the OPA output approximately simultaneously. Such optimal pump and signal input intensities always exist since three-wave mixing equations that describe the dynamics of the process are deterministic and can be always solved backwards.

Each of the following intensity tuning schemes can be used, but the invention is not limited to them.

Scheme 1

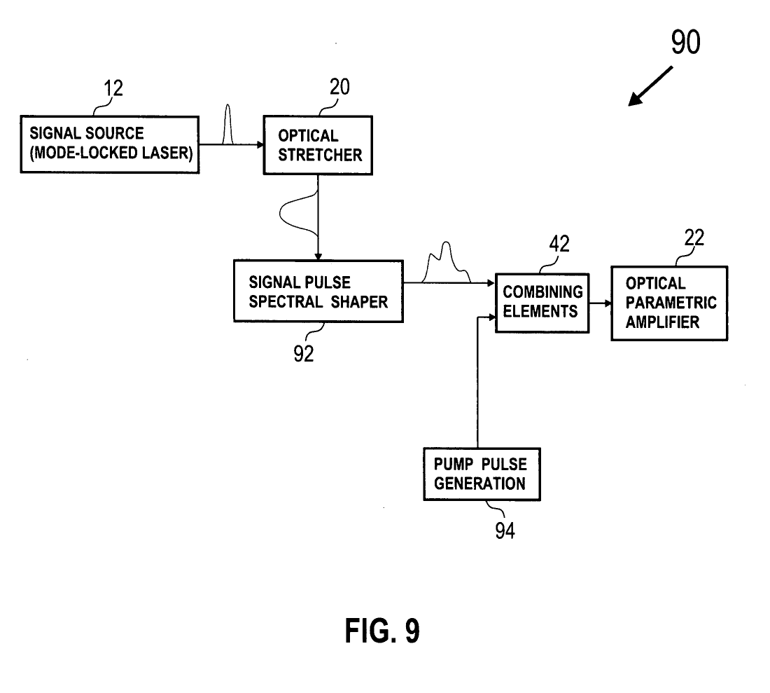

In the first method the signal temporal profile is shaped. Here we use the fact that the signal pulse is chirped and that the signal pulse spectrum is mapped into its temporal profile. In an embodiment of the system shown at 90 in FIG. 9 the signal temporal profile is shaped in spectral shaper 92. Devices that can perform such task are well known to the people skilled in art and include for example liquid crystal modulators or acousto-optic pulse shapers (Dazzler). Passive devices like spectral filters can be also used. The spectral shaper 92 can be placed either before or after the stretcher 20. The system for generating pump pulse 92 may be any of the aforementioned OPCPA pumping methods but is not limited to them.

Scheme 2

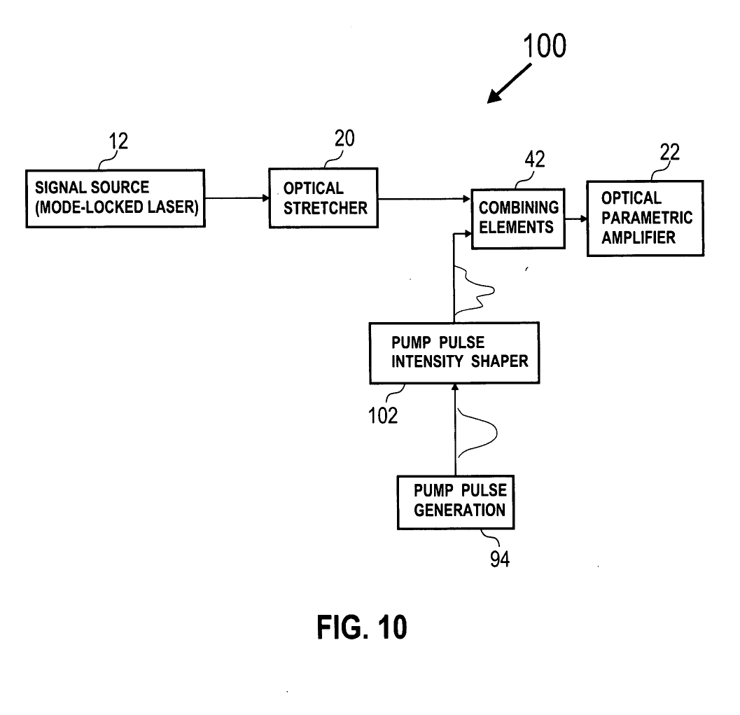

In a second method the pump temporal profile is passively shaped. This method for shaping the pump intensity profile is based on passive pre-shaping of the pump pulses in a three wave mixing process in nonlinear medium 102 in FIG. 10, separate from the particular OPCPA stage where these pump pulses are involved. After an optical pulse goes through the three wave mixing process its spatial and temporal shape will be modified since different spatial-temporal points of the pulse intensity envelope will have different saturation lengths due to different local values of the intensities of the input interacting three waves and also on the local value of the phase mismatch. Therefore, different spatial and temporal points of the pulses will be depleted in different levels which leads to the modulation of the intensity envelope of the output pulses.

Further, the pump pulse energy shaped intensity profile can be converted to another pump pulse with another wavelength by harmonic generation before it interacts with the signal pulse and said other pump pulse can be recombined with the signal pulse in the parametric amplifier. The intensity profile of the wavelength shifted pulse can be optimized by optimizing the intensity profile of the fundamental pulse. The system for generating pump pulse 92 can be any of aforementioned OPCPA pumping methods but is not limited to them. Also systems 90 and 100 can be used with or without compressor 24 after parametric amplification in the amplifier 22.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes”, and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

List of Acronyms

CPA: Chirp pulse amplification
IR: Infrared
OPA: Optical parametric amplification
OPCPA: Optical parametric chirp pulse amplification
SHG: Second harmonic generation
THG: Third harmonic generation
KnBO3: Potassium Niobate
MgO:LiNbO3: Magnesium Oxide doped Lithium Niobate
BBO: Beta-Barium Borate
LBO: Lithium Triborate
KTA: Potassium Titanyl Arsenate
KTP: Potassium Titanyl Phosphate
RTA: Rubidium Titanyl Arsenate
AgGaSe2: Silver Gallium Selenide
AgGaSe: Silver Thiogallate
PPLN: Periodically poled Lithium Niobate
PPKTA: Periodically poled KTA
Nd:YLF: Neodymium doped Yttrium Lithium Fluoride
Nd:YAG: Neodymium doped Yttrium Aluminum Garnet
Nd:YVO4: Neodymium doped Yttrium Vanadate
Yb:YAG: Ytterbium doped Yttrium Aluminum Garnet
RF: Radio frequency

### REFERENCES CITED

U.S. Patent Documents

U.S. Pat. No. 6,181,463 B1* January/2001 Galvanauskas
U.S. Pat. No. 6,873,454* March/2005 Barty
   EU Patent Documents
CN1297268* May/2001 Lin et al
   Other Publications
[1] Perry M D, Mourou G, :Terawatt to Petawatt subpicosecond lasers”, Science, 264 (5161) 917-924 (1994)
[2] A. Dubietis, G. Jonusauskas, and A. Piskarskas, “Powerful femtosecond pulse generation by chirped and stretched pulse parametric amplification in BBO crystal”, Opt. Commun. 88, 437-440 (1992).
[3] I. N. Ross, P. Matousek, M. Towrie, A. J. Langley, and J. L. Collier, “The prospects for ultrashort pulse duration and ultrahigh intensity using optical parametric chirped pulse amplifiers”, Opt. Commun. 144, 125-133 (1997).
[4] (U.S. Pat. No. 6,181,463 B1, which incorporated herein by reference).
[5] EU Patent CN1297268, which incorporated herein by reference).
[6] A. V. Smith, “Crystal Bibliography”, SNLO software documentation, www.sandia.gov/imrl/XWEB1128/snloftp.htm
[7] (U.S. Pat. No. 6,873,454, which incorporated herein by reference).
[8] Giardalben et al, Optics Express, Vol 11, Issue 20, 2511-2524 (2003)
[9] J. Hermann, U. Griebner, N. Zhavoronkov, A. Husakou, D. Nickel, J. C. Knight, W. J. Wadsworth, P. St. J. Russell, and G. Korn, “Experimental evidence for supercontinuum generation by fission of higher-order solitons in photonic fibres”, Phys. Rev. Lett., vol. 88, paper 173901 (2002).

1. An optical pulse amplification system, comprising:
a) a first mode-locked laser for producing a seed laser pulse;
b) a second mode-locked laser for producing a pump laser pulse;
c) pulse stretcher means for stretching said seed laser pulse to produce a stretched seed laser pulse;
d) a nonlinear optical medium and directing means for spatially overlapping and directing said stretched seed laser pulse and said pump laser pulse into said non-linear optical medium and producing an output amplified stretched seed laser pulse; and
e) means for synchronizing the first and second mode-locked lasers to each other such that a time delay between arrival of the first stretched seed laser pulse and said pump laser pulse at the nonlinear optical medium fluctuates in time by an amount shorter than pulse durations of the stretched seed laser pulse and said pump laser pulse to give substantially temporally and spatially overlapped stretched seed laser pulse and pump laser pulses.

2. The apparatus according to claim 1 including a pulse compressor means positioned to receive the nonlinear optical medium output amplified seed laser pulse for compressing said nonlinear optical medium output amplified seed laser pulse to produce a recompressed output amplified stretched seed laser pulse.

3. The apparatus according to claim 1 wherein said pulse stretcher means stretches said seed laser pulses to a pulse duration approximately equal to a pulse duration of said pump laser pulses.

4. The apparatus according to claim 1 wherein the nonlinear medium is an optical parametric amplifier.

5. The apparatus according to claim 1 wherein the nonlinear medium is any one of KnBO₃, MgO:LiNbO₃, BBO, LBO, RTA, KTA, KTP, AgGaSe₂, AgGaSe.

6. The apparatus of claim 1 wherein the nonlinear medium is a quasi-phase matched crystal.

7. The apparatus according to claim 6 wherein the nonlinear medium is a quasi-phase matched crystals selected from the group consisting of PPLN, PPKTP and PPKTA.

8. The apparatus according to claim 1 including an optical amplifier for amplifying the pump laser pulses before being spatially overlapped with the stretched seed laser pulse and directed to the nonlinear medium.

9. The apparatus according to claim 1 including an optical amplifier for amplifying the stretched seed laser pulse before being directed to the non-linear medium.

10. The apparatus according to claim 1 including a first optical amplifier for amplifying the pump laser pulse, and including a second optical amplifier for amplifying the stretched seed laser pulse before being directed to the non-linear medium with the pump laser pulse.

11. The apparatus according to claim 1 wherein said directing means includes diffractive optics selected to give a desired spatial geometry for phase matching of the stretched seed laser pulse and pump laser pulse in said non-linear medium.

12. The apparatus according to claim 1 wherein the first mode-locked laser is a mode locked fibre laser.

13. The apparatus according to claim 1 wherein the second mode-locked laser is a mode locked fibre laser.

14. The apparatus according to claim 1 wherein the first mode-locked laser is a first mode locked fibre laser, and wherein the second mode-locked laser is a second mode locked fibre laser.

15. The apparatus according to claim 1 wherein the first mode-locked laser is a high-bandwidth erbium doped fibre laser emitting laser pulses with a wavelength of 1.5 μm.

16. The apparatus according to claim 1 wherein the first mode-locked laser is a mode locked solid state rare-earth doped laser.

17. The apparatus according to claim 1 wherein the first mode-locked laser is a mode locked Titanium Sapphire laser.

18. The apparatus according to claim 1 wherein the output amplified stretched seed laser pulse has a wavelength in an infrared spectral range from about 0.7 Ãm to about 20 Ãm.

19. The apparatus according to claim 1 including wavelength conversion means for converting a wavelength of the pump laser pulse to a desired wavelength needed for non-linear interaction with said stretched seed laser pulse in said non-linear optical medium.

20. The apparatus according to claim 19 wherein said wavelength conversion means includes a non-linear crystal for harmonic generation.

21. The apparatus according to claim 1 including wavelength conversion means for converting a wavelength of the laser seed pulse to a desired wavelength.

22. The apparatus according to claim 21 wherein said wavelength conversion means includes a non-linear crystal for harmonic generation.

23. The apparatus according to claim 1 including spectral shaping means for shaping a temporal profile of the seed laser pulse located between the pulse stretcher means and the first mode-locked laser to give a pre-selected temporal profile to said laser pulse.

24. The apparatus according to claim 23 wherein said spectral shaping means is an active spectral shaping means selected from the group consisting of liquid crystal modulator and acousto-optic programmable dispersive filter.

25. The apparatus according to claim 23 wherein said spectral shaping means is spectral filter.

26. The apparatus according to claim 1 including spectral shaping means for shaping a temporal profile of the stretched laser seed pulse located between the pulse stretcher means and the nonlinear medium to give a pre-selected temporal profile to said stretched seed laser pulse.

27. The apparatus according to claim 26 wherein said spectral shaping means is an active spectral shaping means selected from the group consisting of liquid crystal modulators and acousto-optic programmable dispersive filters.

28. The apparatus according to claim 26 wherein said spectral shaping means is spectral filter.

29. The apparatus according to claim 1 including passive shaping means for shaping a intensity temporal profile of the pump laser pulse to give a pre-selected temporal profile to said pump laser pulse.

30. The apparatus according to claim 29 wherein said spectral shaping means for shaping a temporal profile of the pump laser pulse includes a second nonlinear optical medium selected such that the pump laser pulse undergoes a three wave mixing process in whereby after the pump laser pulse goes through the three wave mixing process its spatial and temporal shape are modified due to different spatial and temporal points of the pump laser pulse will be depleted in different levels which results in modulation of an intensity envelope of the pump laser pulses output from the second nonlinear optical medium.

31. A method of laser pulse amplification, comprising the steps of:
generating a seed laser pulse from a first mode-locked laser;
stretching said seed laser pulse to produce a stretched seed laser pulse;
generating a pump laser pulse from a second mode-locked laser; and
directing said stretched seed laser pulse and said pump laser pulse into an nonlinear optical medium and producing a nonlinear optical medium output amplified signal pulse, the first and second mode-locked lasers being synchronized to each other such that a time delay between arrival of the first stretched seed laser pulse and said pump laser pulse at the nonlinear optical medium fluctuates in time by an amount shorter than pulse durations of the stretched seed laser pulse and said pump laser pulse to give substantially temporally and spatially overlapped stretched seed laser pulse and pump laser pulses.

32. The method according to claim 31 including compressing said nonlinear optical medium output amplified stretched seed laser pulse to produce a recompressed pulse output amplified stretched seed laser pulse.

33. The method according to claim 31 wherein said nonlinear optical medium is an optical parametric amplifier.

34. The method according to claim 31 wherein said seed laser pulses are stretched to a pulse duration approximately equal to a pulse duration of said pump laser pulses.

35. The method according to claim 31 including amplifying the pump laser pulses before being directed to the non-linear medium.

36. The method according to claim 31 including amplifying the stretched seed laser pulses before being directed to the non-linear medium.

37. The method according to claim 31 including amplifying the pump laser pulses, and including amplifying the stretched seed laser pulses before being spatially overlapped with the amplified pump laser pulses and directed to the non-linear medium.

38. The method according to claim 31 wherein the output amplified stretched seed laser pulse has a wavelength in an infrared spectral range from about 0.7 Ãm to about 20 Ãm.

39. The method according to claim 31 wherein the first mode-locked laser is a mode locked fibre laser.

40. The method according to claim 31 wherein the second mode-locked laser is a mode locked fibre laser.

41. The method according to claim 31 including converting a wavelength of the pump laser pulse to a pre-selected wavelength required for non-linear interaction with said stretched seed laser pulse in said non-linear optical medium.

42. The method according to claim 41 wherein said step of converting a wavelength of the pump laser pulse includes using a non-linear crystal for harmonic generation.

43. The method according to claim 31 including converting a wavelength of the seed laser pulse to a pre-selected wavelength.

44. The method according to claim 43 wherein said step of converting a wavelength of the seed laser pulse includes using a non-linear crystal for harmonic generation.

45. The method according to claim 31 including shaping intensity profiles of the stretched seed laser pulse and the pump laser pulse such that all spatial-temporal points of the stretched laser seed pulse reach gain saturation at an output of the nonlinear medium approximately simultaneously.

46. The method according to claim 45 wherein the step of shaping intensity profiles of the stretched seed laser pulse includes directing the stretched seed laser pulse into an active spectral shaping means prior to directing the stretched seed laser pulse to the nonlinear medium.

47. The method according to claim 46 wherein the active spectral shaping means is selected from the group consisting of liquid crystal modulators, acousto-optic programmable dispersive filters.

48. The method according to claim 46 wherein the step of shaping intensity profiles of the stretched seed laser pulse includes directing the stretched laser seed pulse into a passive spectral shaping means prior to directing the stretched seed laser pulse to the nonlinear medium.

49. The method according to claim 48 wherein the passive spectral shaping means is a spectral filter.

50. The method according to claim 31 including shaping a temporal profile of the pump laser pulse to give a pre-selected temporal profile to said pump laser pulse.

51. The method according to claim 50 wherein said step of shaping a temporal profile of the pump laser pulse includes directing the pump laser pulse into a second nonlinear optical medium selected such that the pump laser pulse undergoes a three wave mixing process in whereby after the pump laser pulse goes through the three wave mixing process its spatial and temporal shape are modified due to different spatial and temporal points of the pump laser pulse will be depleted in different levels which results in modulation of an intensity envelope of the pump laser pulses output from the second nonlinear optical medium.

52. The method according to claim 31 including shaping a temporal profile of the pump laser pulse to give a pre-selected temporal profile to said pump laser pulse by a step of generating the pump laser pulse from another laser pulse through harmonic generation where said another laser pulse has predetermined temporal profile and which undergoes a three wave mixing process thereby producing said pump laser pulse, and wherein different spatial-temporal points of the said another laser pulse will be depleted with different levels giving rise to a specific pump laser pulse temporal profile desired for interaction in the said non-linear optical medium.

53. An optical pulse amplification system, comprising:
a) a first mode-locked laser for producing a seed laser pulse;
b) means for spectrally broadening a portion of the seed laser pulse coupled to the first mode-locked laser for producing a spectrally broadened portion of a seed laser pulse;
c) soliton wavelength selection means, wherein said spectrally broadened portion of a seed laser pulse is directed into said soliton wavelength selection means wherein a soliton wavelength is selected and a duration of the spectrally broadened portion of a seed laser pulse is adjusted to produce a pump laser pulse;
d) pump laser pulse amplifier for amplifying said pump laser pulse;
e) pulse stretcher means for stretching said seed laser pulse to produce a stretched seed laser pulse; and
d) a nonlinear optical medium and directing means for spatially overlapping and directing said stretched seed laser pulse and said pump laser pulse into said non-linear optical medium and producing an output amplified stretched seed laser pulse.

54. The apparatus according to claim 53 including a pulse compressor means positioned to receive the nonlinear optical medium output amplified seed laser pulse for compressing said nonlinear optical medium output amplified seed laser pulse to produce a recompressed output amplified stretched seed laser pulse.

55. The apparatus according to claim 53 wherein said means for spectrally broadening a portion of the seed laser pulse includes a high nonlinearity optical fibre.

56. The apparatus according to claim 55 wherein said high nonlinearity optical fibre includes any one of a tapered fibre, and fibres made of a highly nonlinear glass material, and any one of a micro-structure fiber.

57. The apparatus according to claim 53 wherein said means for soliton wavelength selection is a passive spectral filter placed between the nonlinear medium that has produced spectral broadening and the pump pulse amplifier.

58. The apparatus according to claim 57 wherein said means for soliton wavelength selection is a single fibre Bragg grating, or a combination of many fiber Bragg gratings, positioned between the nonlinear medium that has produced spectral broadening and the pump pulse amplifier.

59. The apparatus according to claim 57 wherein said passive spectral filter is a birefringent filter.

60. The apparatus according to claim 57 wherein said passive spectral filter is a prism or combination of many prisms.

61. The apparatus according to claim 57 wherein said passive spectral filter is a single thin-film filter, or a combination of many thin film filters;

62. The apparatus according to claim 57 wherein said passive spectral filter is a single Fabry-Perot étalon, or a combination of many Fabry-Perot etalons.

63. The apparatus according to claim 58 wherein said passive spectral filter is an optical interferometer.

64. The apparatus according to claim 53 wherein said means for soliton wavelength selection is a passive spectral filter placed within said pump amplifier.

65. The apparatus according to claim 64 wherein said means for soliton wavelength selection is the gain linewidth of the active medium in the pump pulse amplifier

66. The apparatus according to claim 65 wherein said means for soliton wavelength selection is a single fibre Bragg grating, or a combination of many fiber Bragg gratings, positioned within the pump pulse amplifier.

67. The apparatus according to claim 64 wherein said passive spectral filter is a birefringent filter.

68. The apparatus according to claim 64 wherein said passive spectral filter is a prism or combination of many prisms.

69. The apparatus according to claim 64 wherein said passive spectral filter is a single thin-film filter, or a combination of many thin film filters;

70. The apparatus according to claim 64 wherein said passive spectral filter is a single Fabry-Perot étalon, or a combination of many Fabry-Perot etalons.

71. The apparatus according to claim 64 wherein said passive spectral filter is an optical interferometer.
